(19) United States
(12) Patent Application Publication
(10) Pub. No.: US 2008/0037753 A1
(43) Pub. Date: Feb. 14, 2008

(54) Call priority management system for communication network

(75) Inventor: Markus A. Hofmann, Fair Haven, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/482,994

(22) Filed: Jul. 7, 2006

(51) Int. Cl. H04M 3/42

(52) U.S. Cl. 379/208.01

(57) ABSTRACT

A call priority management system is implemented on or as part of one or more communication networks, for allowing authorized calling parties to control call disposition when the party being called is already on another call. In operation, when a first terminal initiates communication with a second terminal that is already in communication with a third terminal, the system determines if the newly initiated communication is a priority communication. By “priority” communication, it is meant a communication associated with a user and/or terminal having a designated or assigned privilege to interrupt ongoing communications at the second terminal. If so, the ongoing communication between the second and third terminals is interrupted, and a communication link is established between the first and second terminals. Prior to interruption, the calling party may be informed that the second/called terminal is already engaged in another call, for optionally interrupting the ongoing call.

### FIELD OF THE INVENTION

The present invention relates to communications and, more particularly, to user services for call management in a wireless network or other communication network.

### BACKGROUND OF THE INVENTION

In some telecommunication systems, if a calling party attempts to call another user who is already engaged in a telephone call, the calling party is presented with a busy signal. The only option for proceeding is for the calling party to hang up (e.g., deactivate the telephone) and call again later. Some telecommunication service providers offer services such as “call waiting” and “call forward when busy,” in which a subscribing party is notified about incoming calls even when already engaged in another call. For example, in the case of “call waiting,” if a call is initiated to a subscriber who is already on the phone, a special tone is generated to inform the subscriber that someone else is calling. The subscriber has the option to ignore the tone, or to put the current caller on “hold” and switch to the incoming call. Typically, the subscriber depresses the telephone receiver or a flash button to answer the second caller. To return to the first caller, the subscriber presses the receiver or flash button again.

Subscribers may also be given options for handling or routing incoming calls. For example, in the case of “call forward when busy,” a subscriber specifies another call destination to which incoming calls are forwarded when the subscriber is already on the phone. For a home phone, incoming calls may be forwarded to a mobile phone or other wireless unit, a voice-mail system, or the like. In the case of an “auto call-back” service, if a calling party receives a busy signal when attempting to reach another party, the service automatically initiates a call between the calling party and busy party once the busy party is off the phone.

With “call waiting”-type services, it is the decision of the called party whether to accept an incoming call when already on the line with another party. The calling party has no control over call disposition. The same is true for “call forward when busy” and “auto call-back.” If the incoming call relates to an emergency situation, or if the calling party otherwise expects to have the call answered, this can be disadvantageous. For example, in the case of a parent attempting to call a teenage child who is on the phone with friends for hours at a time, the child may be disinclined to switch to incoming calls under the prompting of call waiting.

### SUMMARY OF THE INVENTION

The present invention relates to a call priority management system for a communication network. The call priority management system allows an authorized calling party to control call disposition when the called party is already on another call or other communication. Instead of generating a “busy” signal or activating a “call waiting” service, the call priority management system provides the calling party with an option for interrupting the active call, without requiring the called party's concurrent consent or approval.

In another embodiment, the call priority management system is implemented as part of a communication network where users communicate with one another using terminals. (By “terminal,” it is meant a device configured for electronic communication over the network, such as a computer, telephone, or wireless unit.) In operation, when a communication is initiated at a first terminal to a second terminal already in communication with a third terminal, the system determines if the newly initiated communication is a priority communication. By “priority” communication, it is meant a communication originating from or otherwise associated with a user and/or terminal having a designated or assigned privilege to interrupt ongoing communications at the second terminal and/or of the user currently using the second terminal. If so, the communication between the second and third terminals is at least temporarily interrupted, e.g., terminated or put on hold. (In other words, the system in effect bypasses the network's normal protocol for handling incoming calls when the called party is already on another call/communication.) Then, a communication link or channel is established between the first and second terminals. This ensures that the user of the first terminal will get through to the second terminal, even if the second terminal is not configured for call waiting, or if the user of the second terminal might be disinclined to respond to call waiting.

The call priority system may be used in situations where a user wants to be contacted by one or more designated priority users, or in situations where a user wants to contact one or more other users in a priority manner. For example, in the case of a parent and child (each having a wireless unit or other terminal), the parent may want to ensure that the child is able to get through to the parent's terminal, and that the parent is able to get through to the child's terminal, e.g., in emergency situations. In this case, at each terminal the other terminal is designated as being authorized for priority communications.

In another embodiment, prior to interrupting an active communication, the call priority system informs the calling party (e.g., the user initiating communication to a second terminal) that the called/second terminal is already engaged in another call. The calling party is given the option of interrupting the active call or not. For example, if the call is important, or if there is an emergency, the calling party may choose to have the active communication interrupted. If the call is not deemed important enough to warrant interrupting the active call, the calling party may choose against having the active call interrupted. Information identifying the third terminal (e.g., the terminal that the called terminal is already in communication with) and/or the user of the third terminal (if available) may be transmitted to the calling terminal, for use by the calling party in determining the relative importance of the active call and the newly initiated call. For example, the identifying information may be “caller ID” information. Other information regarding the active communication may also be provided to the calling terminal, such as call duration.

In another embodiment, the determination of whether the communication initiated from the first terminal to the second terminal is a priority communication is based on information received from the first (calling) terminal. For example, in initiating the communication, the first terminal may transmit its communication identifier to the network. If the identifier is listed as having priority status in a record associated with the second terminal, the initiated communication is deemed to be a priority communication for possibly interrupting the active communication between the second and third terminals. Alternatively, the first terminal may transmit a priority code, or initiate communication with the second terminal using a special priority communication identifier assigned to the second terminal. (In other words, the terminal would have one identifier, e.g., telephone number, for standard calls, and another for priority calls.) Determinations of call priority may also be based (in whole or in part) on user identification. For example, if communications in the network are based principally on user identification, the identifier of the calling user may be cross-referenced to a record associated with the called user. If the calling user identifier is listed as having priority status, the incoming communication is deemed a priority communication, regardless of the particular terminals involved.

In another embodiment, the system is configured for use with a “reverse 911” system, for interrupting active communications upon initiation of a reverse 911 call. A reverse 911 call is an automatic electronic communication between a municipal authority or other government authority and one or more local residents, for informing the residents about an emergency situation in the nearby area, e.g., weather alerts, evacuations, or abductions. In the call priority management system, upon initiation of a reverse 911 call to a user terminal already in active communication with another terminal, the active communication is either automatically terminated or put on hold until the end of the reverse 911 call.

### BRIEF DESCRIPTION OF THE DRAWINGS

The present invention will be better understood from reading the following description of non-limiting embodiments, with reference to the attached drawings, wherein below:

FIG. 1 is a schematic view of a communication network;

FIG. 2 is a schematic view of a call priority management system for a communication network (such as the network shown in FIG. 1), according to an embodiment of the present invention;

FIG. 3A is a flow chart showing operation of the system on a calling terminal;

FIG. 3B is a flow chart showing operation of the system at the network level;

FIG. 3C is a flow chart showing operation of a call interrupt protocol portion of the system;

FIG. 4 is a flow chart illustrating another example of the system in operation; and

FIG. 5 is a schematic view of an additional embodiment of the call priority management system, implemented in the context of a VoIP or similar network.

### DETAILED DESCRIPTION

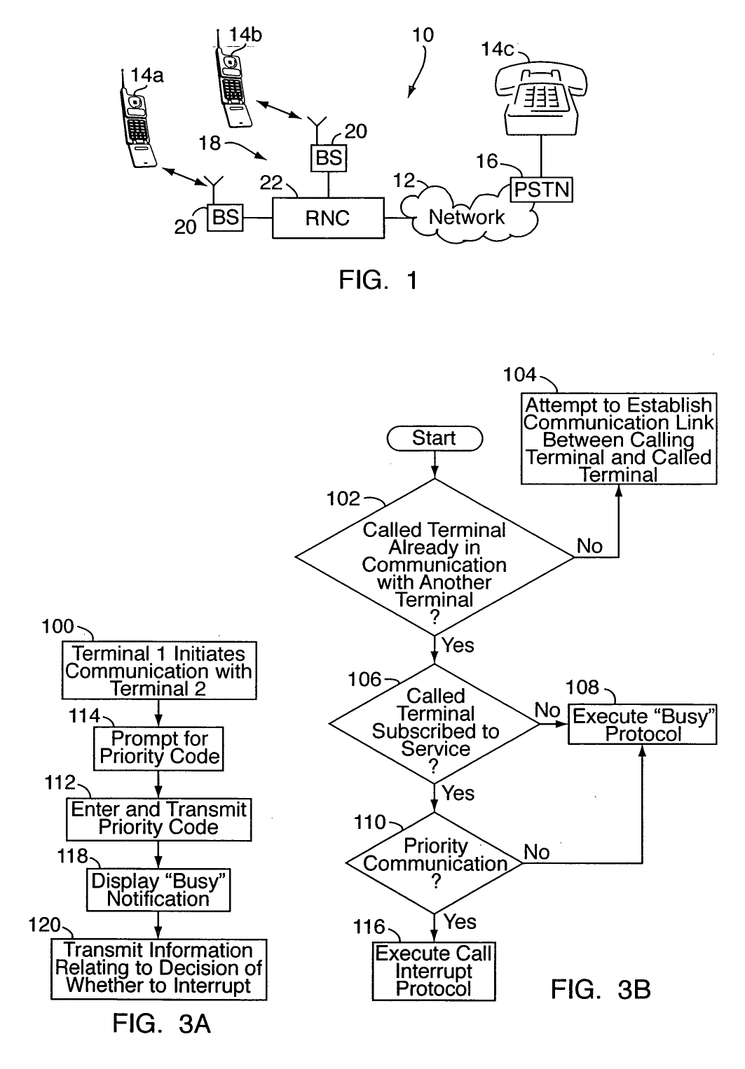

With reference to FIGS. 1-5, a system 10 is implemented on or as part of one or more communication networks 12 for managing call priority. The system 10 allows authorized calling parties to control call disposition when the called party is already on another call. In operation, when a first terminal 14a initiates communication with a second terminal 14b already engaged in active communication with a third terminal 14c, the system 10 determines if the newly initiated communication is a “priority” communication. (By “priority” communication, it is meant a communication originating from or otherwise associated with a user and/or terminal having a designated or assigned privilege to interrupt ongoing communications at the second terminal 14b or of the user currently using the second terminal 14b.) If so, the ongoing active communication 15 between the second and third terminals 14b, 14c may be interrupted, and a communication link/channel established between the first and second terminals 14a, 14b. If the active communication is interrupted, the third terminal 14c may be put on hold, including connection to a media server for playback of an announcement regarding the interruption, a personalized greeting, music, or other “on hold” media content such as text, video, and/or audio. Prior to interrupting an active call, the system 10 may be configured to inform the calling party (e.g., the user initiating communication to the second terminal 14b) that the called/second terminal 14b is already engaged in another call, and to provide the calling party with the option of interrupting the ongoing call or not.

The system 10 may be used in situations where a calling party has a pre-established relation with a called party, and desires to possibly communicate with the called party regardless of whether the called party has a call waiting service or is willing or inclined to switch to an incoming call under the prompting of call waiting. For example, in the case of family use, certain children may be disinclined to switch to an incoming call when notified of such by a call waiting service, e.g., if they are talking to friends. Under the system 10, a parent or other calling party with priority privileges is given the option of interrupting the active call, for emergency purposes or otherwise.

The system 10 of the present invention is suitable for implementation on various types of communication networks 12, including stand-alone networks and interconnected networks. For example, the network(s) 12 may include wire-line networks such as DSL networks, public switched telephone networks (PSTN) 16, IP (Internet protocol)-based networks such as the Internet or other packet data networks, local area networks (LAN), and wireless networks 18 such as those using CDMA, GSM, IEEE 802.11x, and/or UMTS communications or the like. As noted above, the terminals 14a-14c are electronic devices capable of communicating with one another over the network(s) 12, and may include, for example, computer units, wire-line connected communication devices such as conventional telephones, and/or wireless units such as mobile phones, wireless PDA's, wireless devices with high-speed data transfer capabilities, such as those compliant with “3-G” or “4-G” standards, “WiFi”-equipped computer units, and the like. The terminals 14a-14c communicate with one another over the networks 12 in a standard manner, according to the communication protocols in place on the networks, and depending on the particular networks and the particular types of terminals. For example, in the case of wireless units 14a, 14b and a wireless network 18, the network may include one or more fixed base stations (“BS”) 20 having various transceivers and antennae for wireless, radio-frequency (RF) communications with the wireless units over one or more RF channels, in a manner based on the wireless communication method and protocol used. A radio network controller (“RNC”) 22 interconnects the base stations and performs the signaling functions necessary to establish calls and other data transfer to and from the wireless units. It also acts as the interface between the wireless/RF end of the network and the wire-line portion of the network and external wire-line networks. For example, a wireless network 18 typically includes landline portions (e.g., a backbone connecting the base stations and radio network controller), and is typically connected to a PSTN 16 and/or to an IP network, which allows the wireless units to communicate with terminals connected to the PSTN or IP network, such as landline phones and computer terminals.

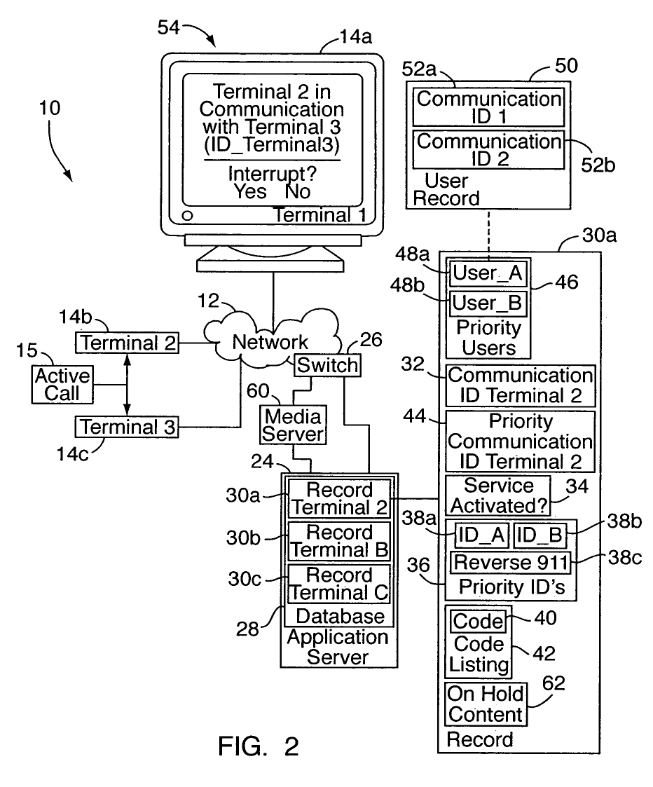

As indicated in FIG. 2, the system 10 may include an application server terminal or other service broker 24 connected to or otherwise part of the network(s) 12. For example, the application server 24 may be connected (directly or indirectly) to a network switch 26, e.g., one or more network components (such as a radio network controller, mobile switching center, data router, or the like) where message, call routing, and/or other communication functions are carried out. The application server 24 is provided for carrying out one or more of the functions of the system 10. Alternatively, the functionality of the system 10 may be implemented, in whole or in part, by way of one or more scripts, other software programs, suites of software programs, and/or hardware/software modules in place on the RNC 22 or other switch 26, or on an existing network server or the like.

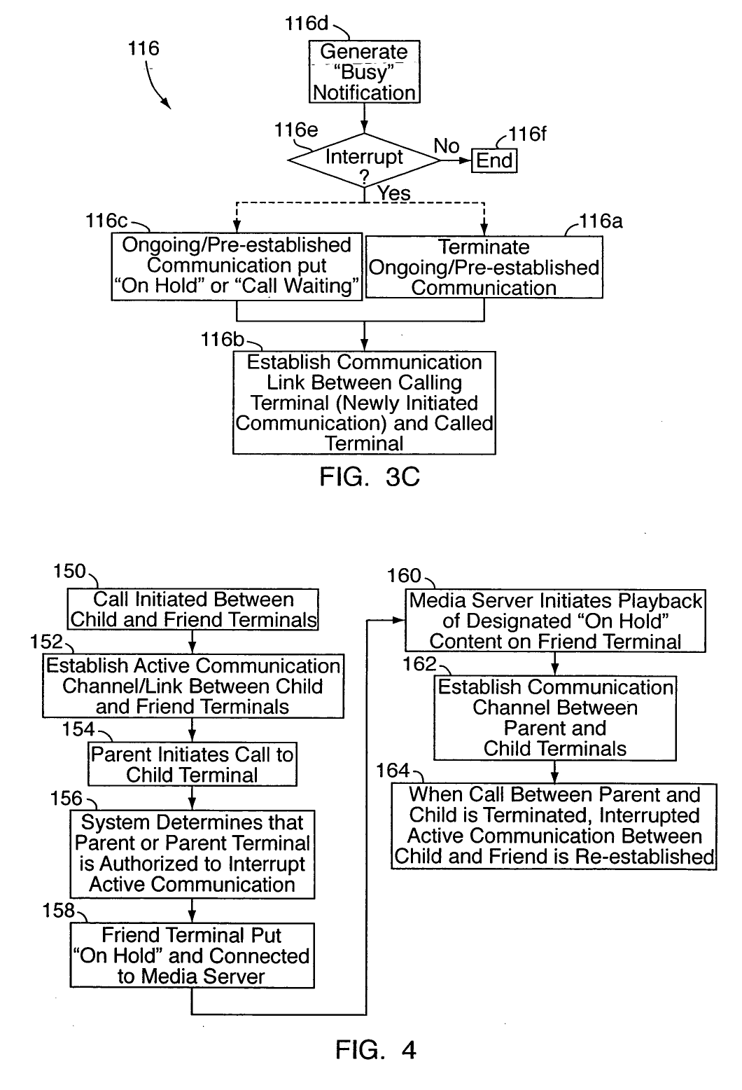

Operation of the system 10 is illustrated in more detail in FIGS. 2 and 3A-3C. As indicated above, the system 10 is configured to determine if a newly initiated communication is a priority communication, when the called party is already on another call, for possibly interrupting the pre-existing, active call. As such, when a first terminal 14a initiates communication with a second terminal 14b over the network 12, as at Step 100 in FIG. 3A, it is initially determined if the second/called terminal 14b is already engaged in communication with another terminal 14c, as at Step 102 in FIG. 3B. If not, e.g., if the called terminal 14b is free to accept an incoming communication, at Step 104 the network 12 attempts to establish a channel or link between the two terminals, according to the communication protocols in place on the network. For example, if the two terminals are telephones (e.g., wire-line phones or mobile telephones), the network 12 informs the called terminal 14b of the incoming communication, for the called terminal 14b to initiate a ring tone or other user notification. If the called terminal 14b is already on another call or other communication, at Step 106 it is determined whether the called terminal 14b is subscribed or otherwise subject to the call priority system 10. For example, it may be the case that the call priority system 10 is made available to network users as an optional service, to which users sign up or subscribe. If all users are subscribed to the system (e.g., for use with reverse 911 calls, as described below), this step may not be necessary.

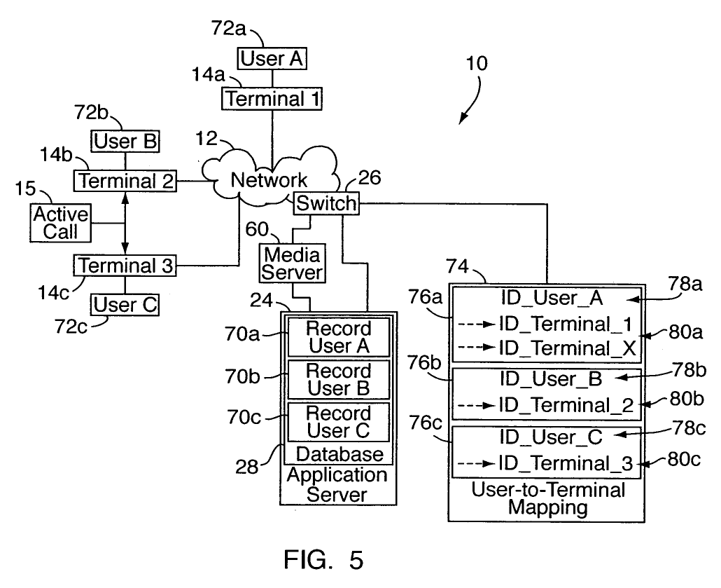

In the system 10, determinations of subscriber status and call priority may be carried out primarily with respect to user-based identifiers and records, instead of, or in addition to, terminal records and identifiers. This is described in more detail below with respect to FIG. 5.

For determining whether the called terminal 14b is subscribed to the system 10, a notation of such may be recorded in a profile or other data record associated with the called terminal (and/or the called user, as described below). The record may be an existing record of the called terminal, such as a record in a network home location register or the like, or it may be a record stored on the application server 24. For example, the application server 24 may include a database 28 containing a record 30a-30c for each terminal subscribed to the call priority system/service 10. Each record 30a-30c includes the communication identifier 32 of its associated terminal, e.g., telephone number, e-mail or messaging address, or other identifier for initiating communication with the terminal over the network 12. For a first terminal 14a to initiate communication with a second terminal 14b, the first terminal will typically transmit the communication identifier 32 of the second terminal 14b to the network 12, as part of the network signaling protocol. If the second terminal 14b is in communication with a third terminal (Step 102), the system 10 cross-references the communication identifier 32 of the called terminal 14b to the database 28. If the communication identifier 32 is listed in one of the records (or in an index or the like), this indicates that the called terminal 14b is subscribed to the call priority service. Otherwise, the called terminal 14b may be considered to be unsubscribed to the service. Additionally, the records 30a-30c may each include an activation field or entry 34 indicating whether the service is activated or deactivated for the terminal in question. For example, even if a terminal is subscribed to the call priority service, the system 10 may be configured for an authorized user to turn the service on or off.

Alternatively, instead of utilizing subscriptions, the call priority service may be made available to all terminals generally. In this case, at Step 106 the system would determine if the call priority service has been activated for the called terminal. This could be done by cross-referencing the communication identifier 32 of the called terminal to a database 28 containing records 30a-30c for each terminal on the network 12. Each record would include an activation field 34 indicating whether the service had been “turned on” for the particular terminal.

At Step 106, if it is determined that the called terminal 14b is not subscribed or otherwise subject to the call priority system or service 10 (if applicable), or if the service has not been activated for the called terminal, at Step 108 the system/network executes its standard “busy” protocol, this is, it continues as it normally would according to the communication protocols of the network for handling an incoming call where the called party is already in communication with another network. For example, the network 12 may initiate generation of a “busy” signal at the calling terminal 14a, or it may initiate activation of a “call waiting” or “call forward when busy” service. On the other hand, if it is determined at Step 106 that the called terminal 14b is subscribed to the call priority system or service 10, and/or that the service has been activated for the called terminal, at Step 110 it is determined whether the incoming call from the first terminal 14a is a priority communication.

Generally speaking, determinations of whether or not the incoming call from the first terminal 14a is a priority communication will typically be based on whether the calling terminal 14a and/or a user of the calling terminal 14a is authorized for interrupting active communications between the called terminal 14b and other terminals. In one embodiment, priority authorizations are set up using calling terminal communication identifier. Here, the record 30a for the called terminal 14b includes a field or other entry 36 containing one or more “priority” communication identifiers 38a-38c. If the communication identifier of a calling terminal is listed in the priority field 36, communications from that terminal are deemed to be priority communications. For example, in the case of a parent and child (using wireless units 14a, 14b, respectively), the parent may add the communication identifier 38a of the parent's wireless unit 14a to the priority field 36 of the data record 30a associated with the child's wireless unit 14b. When the parent calls the child from the parent's wireless unit 14a, the communication identifier 38a of the parent's wireless unit 14a is transmitted to the network, as is the identifier 32 of the child's wireless unit 14b. For locating the record 30a associated with the child's wireless unit 14b, the identifier 32 of the child's wireless unit 14b is cross-referenced to the database 28. Then, the identifier 38a of the parent's wireless unit 14a is cross-referenced to the priority field 36. If the identifier 38a is listed in the priority field 36, the communication initiated at the parent's wireless unit 14a is considered to be a priority communication.

As should be appreciated, basing determinations of call priority on calling terminal communication identifiers has the effect of limiting the service to particular terminals. Thus, for example, if parent and child wireless units are set up in the manner described above, the parent will not be able to initiate a priority communication unless the parent uses his or her own wireless unit. To increase service portability, for basing priority determinations on user instead of terminal, other means may be utilized for designating authorized calling parties. For example, in another embodiment, after a communication is initiated at a first terminal 14a to a second terminal 14b, and after Step 106 is carried out, at Step 112 the user of the first terminal 14a enters an alphanumeric priority code 40 (e.g., set of letters and/or numbers) into the terminal 14a, which is transmitted to the system 10. (Optionally, at Step 114 the user may be prompted to enter the code.) The record 30a associated with the called terminal 14b contains a code field or other entry 42 listing one or more codes. If the code 40 entered at the calling terminal 14a is listed in the code field 42, the communication initiated at the calling terminal 14a is deemed to be a priority communication. Thus, a user with priority privileges may use any terminal for contacting the called terminal 14b. The system 42 may be configured for a user to enter the code 40 at different time points. For example, the code may be entered in the calling terminal 14a as a string at the end of the called terminal's communication identifier 32, e.g., XXX-XXX-XXXX-code.

In another embodiment, a terminal 14b is provided with a priority communication identifier 44. The priority identifier 44 is formatted the same as any other communication identifier in the network (e.g., as a telephone number), but is supplemental to the terminal's main, non-priority identifier 32. Both identifiers 32, 44 may be used for communication with the terminal 14b. However, if a communication is initiated using the priority identifier 44, communications from the calling terminal are automatically deemed to be priority communications. Thus, following the example given above, a child's wireless unit can be outfitted with the two identifiers 32, 44. The primary identifier 32 is disseminated to non-priority users for use in calling the child's wireless unit. A parent or other priority user, however, may call the child's wireless unit 14b using the priority identifier 44. If the priority identifier 44 is used, as determined at Step 110, the communication is deemed to be a priority communication.

The system 10 may be further adapted to accommodate network call forwarding services or other features of the network that interrelate various terminals and/or communication identifiers, for determining call priority status. For example, if the network includes a call forwarding service, and if the communication identifier of a calling terminal 14a is not listed as having priority status in the called terminal's profile or other record 30a, the system 10 may check the call forwarding status of each of the priority communication identifiers 38a-38c listed in the record. If the call forwarding status indicates that calls for a particular priority identifier are being forwarded to the calling terminal, then the calling terminal will be given priority status.

Instead of directly deciding whether to grant priority status to an initiated communication by way of communication identifiers, codes, or the like, the system 10 may be configured for the use of indirect designations on a user-by-user basis. For example, each terminal's profile or other record 30a-30c may include a “priority users” field or other entry 46 containing a list of priority users 48a, 48b, designated by name, nickname, primary communication identifier, or the like. Associated with each listing 48a, 48b is a user record 50 in the database 28 or elsewhere. The user record 50 is maintained and accessed by the designated user, and contains a listing of the communication identifiers 52a, 52b associated with terminals that the user may use or is currently using. For determining if an initiated communication is a priority communication, the system compares the calling terminal's communication identifier 32 to the records 50. If it is listed in one of the records, the initiated communication is given priority status. Such a configuration promotes portability, since the user record 50 may be easily accessed and modified by the user, e.g., from a terminal 14a, for conveniently adding and removing communication identifiers 52a, 52b as needed. For example, in the case of parent and child wireless units, the record 30a associated with the child's wireless unit 14b could list “Mom” as one of the priority users 48a, 48b. The record 50 associated with the “Mom” entry contains the communication identifier 52a of the wireless unit 14a that the parent normally uses. However, if the parent temporarily switches to another wireless unit, the parent accesses the record 50 and adds the communication identifier of the new wireless unit to the record 50. When the parent calls the child from the new wireless unit, its communication identifier is compared to all the records 50 linked to the record 30a of the child's wireless unit, for determining priority status. Similar arrangements are possible.

Similarly, the system 10 may be configured for use with networks 12 that primarily identify users rather than terminals, such as those using SIP or VoIP. (“VoIP” stands for voice over IP (Internet protocol), in which voice signals are sent as addressed data packets over an IP network.) In particular, in VoIP networks, users call users, rather than terminals calling terminals. Whenever a user commences use of a terminal, the network maintains a mapping or registry indicating that the user is currently reachable and is using the particular terminal. A single user can be registered at multiple terminals. For a calling party to initiate a call to the user, the calling party uses an identifier associated with the user. Based on the user identifier, the network first refers to the map/registry for looking up the terminals currently associated with the user. Then, the network routes the call appropriately.

Use of the system 10 in the context of such a network is illustrated in FIG. 5. There, the application server database 28 includes a record 70a-70c for each user 72a-72c on the network 12. For carrying out communication operations, the network 12 includes a user-to-terminal mapping or registry 74. The map 74 includes an entry 76a-76c for each user 72a-72c, which correlates user identifier 78a-78c to the communication identifier(s) 80a-80c of the terminals currently associated with the user. In operation under the system 10, when a first user 72a (“user A”) calls a second user 72b (“user B”) and user B 72b is already in active communication with a third user 72c (“user C”), the system first determines is user B 72b is subscribed to the service. This may be done by cross-referencing user B's identifier 78b to the database 28, for accessing user B's profile/record 70b. If user B is subscribed to the service, the system then determines if user A is authorized to interrupt the active call. This may be done by cross-referencing user A's identifier 78a to user B's profile/record 70b, for determining if user A's identifier is listed in the priority ID list 36 of user B. These operations are independent of the particular terminals currently in use. However, if the active communication is to be interrupted, the system 10 then cross-references the user identifiers 78a-78c to the map/registry 74 for looking up the users' current terminals 80a-80c. This information is used for carrying out the signaling functions necessary to interrupt the active call in a manner as described above.

Determinations of call priority may be based on both terminal and user. Here, upon initiation of a call to a busy party, the system accesses the database 28 for checking if the calling terminal OR the calling user is listed as being authorized for call interruption.

Referring back to FIG. 3B, if it is determined at Step 110 that an incoming communication is not a priority communication, the process continues at Step 108 for executing the network busy protocol. Otherwise, for priority communications, at Step 116 the system carries out a “call interrupt” protocol for possibly interrupting the active communication between the called terminal 14b and the third terminal 14c. As should be appreciated, only authorized terminals/users are allowed to interrupt ongoing calls. For example, upon initiation of a communication at a first terminal 14a to a second terminal 14b, the system 10 first checks if the terminal 14a (or the user of terminal 14a) is authorized to interrupt an active call on the second terminal 14b (or of the user using the second terminal 14b). Without this authorization verification process, unauthorized users would be able to interrupt phone calls or other communications, thereby disrupting network operation.

As shown in FIG. 3C, the call interrupt protocol may be configured in one of several ways, depending on the particular functionality desired for the system 10. For example, at Step 116a the system 10 may automatically terminate the pre-existing communication between the called terminal 14b and the third terminal 14c, and then establish a communication channel or link between the calling terminal 14a and the called terminal 14b, as at Step 116b. Alternatively, the system 10 may put the pre-existing, active communication in a “hold” or “calling waiting” status, as at Step 116c, and then establish a communication channel or link between the calling terminal 14a and the called terminal 14b (Step 116b). This enables the user of the called/second terminal 14b to optionally switch back to the original communication. In another embodiment, at Step 116d the system 10 generates a notification 54 for purposes of informing the user of the calling terminal 14a that the called terminal 14b is engaged in an active communication with another terminal. At Step 118, the notification 54 is displayed on the calling terminal 14a. The notification 54 may include information identifying the third terminal 14c, such as the communication identifier of the third terminal and/or “caller ID” information associated therewith. The notification 54 may also include information identifying the user of the third terminal 14c, if available, as well as additional information relating to the active communication, such as call duration. This may enable the user of the calling terminal 14a to assess the relative importance of the active call and the newly initiated call. At Step 120, the user is given the option of interrupting the ongoing communication. The user's decision to interrupt or not interrupt is transmitted back to the system 10 over the network 12, and is assessed at Step 116e. If the decision is not to interrupt, the initiated call may be terminated, as at Step 116f, or the process may continue at Step 108 for executing the network busy protocol. If the decision is to interrupt, the process continues as at Step 116a or Step 116c above. The system may be configured for automatically reconnecting or reestablishing the original active call once the priority call is terminated.

The system 10 is applicable for use with “reverse 911” systems, for interrupting ongoing calls or other communications upon initiation of a reverse 911 call. A reverse 911 call is a call initiated by a municipal authority or other government authority to local users' telephones or other terminals, for informing the users about an emergency situation in the nearby area, e.g., weather alerts, evacuations, or abductions. Typically, a computerized system operated by the municipality carries out the reverse 911 calls automatically, using an electronic phone directory or the like and pre-recorded or computer-generated messages. For use with a reverse 911 system, the system 10 of the present invention could automatically include the reverse 911 system communication identifier 38c in each user profile/record 30a-30c, as a user un-modifiable “background” element. Upon initiation of a reverse 911 call, the pre-established, ongoing communication could either be automatically terminated (Step 116a) or put on call waiting hold (Step 116c). With respect to reverse 911 calls, the call priority service of the system 10 may be optionally activated for each user, or it may be mandatory for all users in the network 12, with individual users subscribing to the service for further, personalized functionality.

The system 10 may be configured for the optional use of different priority levels, which correspond to different levels of functionality in the system 10. For example, communications initiated by users or terminals with a “high” or “emergency” priority level may result in automatic termination of the pre-existing communication between the called and third terminals (Step 116a), while communications initiated by users or terminals with a lower priority level may result in optional interruption (Step 116d, etc.)

As noted above, the functionality of the system 10 will typically be offered as a network service to users, either free or as a subscription service. In either case, interested users access the application server 24 to establish and configure user accounts, including the profiles/records 30a-30c, 50. A user interface may be provided for accessing the application server 24 for this purpose. For example, the terminals 14a-14c could be provided with a hardware and/or software module acting as an interface to the application server. (In the case of a mobile phone or other wireless unit the function could be accessible using the phone's menu system, with the phone and application server exchanging data for enabling the user to establish and configure a profile/record 30a-30c.) Other options include, but are not limited to, a designated website or other Internet interface, remote access using a short message service, a telephone access system (e.g., users call a designated number and are provided with voice prompts for accessing and modifying accounts and associated records), or the like. Upon accessing the user interface, the user is provided with options for establishing a record 30a-30c, 50, including subscription options if applicable. The account/record access system will typically include user authentication means such as password protection. Additionally, certain sub-portions or sub-features of the records 30a-30c, 50 may be provided with separate passwords or other authentication means for limiting access to certain users. For example, a parent may wish to prevent a child user from modifying the listing 36 of priority users in the record 30a.

The profile/record 30a for a terminal 14b will typically include the communication identifier 32 associated with the terminal. The record 30a may also include other user data such as name, account number, and the like. After subscribing to the service (if applicable) and establishing a record 30a, the user populates the record with the communication identifiers 38a-38c of terminals to be granted priority communication status. Alternatively, the record may be populated with one or more priority codes 40, priority users 48a, 48b, or the like. In certain cases, someone other than the intended user of the terminal may configure the record, e.g., a parent.

As indicated above, when an incoming communication from a first terminal 14a to a second terminal 14b is given priority status, the active communication between the second and third terminals 14b, 14c is either terminated or put on hold. If the user of the third terminal 14c is not informed of this occurrence, e.g., if the line goes silent, the user may think that the call was dropped, or that the user of the second terminal 14b terminated the communication abruptly. Accordingly, the system 10 may be configured to initiate playback of a message at the second terminal 14b for informing the user of the second terminal that the active call has been put on hold, or was terminated due to an incoming priority call. For this purpose, the system 10 may include a media server 60 connected to the network 12. When the active communication is terminated or put on hold, the media server 60 is controlled to transmit the desired message or other content to the second terminal 14b over the network 12. For example, there may be a pre-recorded message indicating that the call has been put on temporary hold, followed by music. The message content may be customized and/or selected on a user-by-user basis. For this purpose, each profile/record 30a-30c may include an “on hold content” field 62 identifying one or more messages, greetings, or other media files for playback to an “on hold” user. Greetings may be recorded and stored on the terminal, media server, or elsewhere in the network, using standard methods. For example, the system could be configured for recording a greeting spoken into the microphone of a user terminal. Prior to connecting to the calling terminal 14a, a greeting or announcement may also be played over the called terminal 14b for informing the user of the impending interruption.

FIG. 4 illustrates another example of the system 10 in operation, including playback of an “on hold” greeting, in the situation where a parent attempts to call a child that is already on the phone with a friend. At Step 150, a call is initiated between two terminals 14b, 14c over a network 12, according to the communication/signaling protocols in place on the network, e.g., SIP or the like. For example, the terminals might be mobile phones or wire-line phones. (In this example, the child is using a first one of the terminals 14b, and the child's friend is using the other terminal 14c.) At Step 152, the network 12 establishes a bearer communication channel between the two terminals 14b, 14c, resulting in an active call between the two terminals. At Step 154, the parent initiates a call, at the parent's terminal 14a, to the child's terminal 14b. This results in various signaling messages being sent to the network for call establishment. The signaling messages (possibly including the communication identifiers of the parent and child terminals) are forwarded to the application server 24. At Step 156, the application server 24 determines that the parent and/or the parent terminal 14a are authorized to interrupt the active call between the child and friend. (This process is described above.) Optionally, information is displayed on the parent's terminal indicating that an active call is in progress, and giving the parent the option of interrupting the call or not. At Step 158, the friend's terminal 14c is referred to the media server 60. This results in the active call being interrupted, and the friend's terminal 14c being connected to the media server 60. At Step 160, the media server initiates playback of an announcement or other content 62 over the terminal 14c, while the terminal 14c is on hold. At Step 162, the application server 24 refers the child's terminal 14b to the parent's terminal 14a, resulting in a communication channel being established between the two terminals 14a, 14b. At Step 164, when the call between the terminals 14a, 14b is terminated, the application server 24 receives signaling messages to this effect, and redirects the parked call (terminal 14c) on the media server 60 back to the child's terminal 14b. The call between the child and friend terminals 14b, 14c, previously interrupted by the system 10, is thereby reconnected.

As should be appreciated, although the records 30a-30c have been shown as being stored on the application server 24, each terminal's record could instead be stored locally on the terminal, with the system 10 accessing the record on the terminal when a communication is initiated to the terminal within the context described above.

Although the notification 54 has been illustrated as being displayed on a terminal in text form (see FIG. 2), the notification may include data in other forms, such as pictures, video, and/or audio. When the terminal receives the notification, it automatically executes the data, in whatever form provided, for display or playback to the user according to the format of the data. For example, the notification 54 could take the form of an audio notification generated by an interactive voice response (IVR) system, e.g., “The party you are trying to reach is currently talking to {ID_User_Terminal 3}. The call has already lasted {numeric_value} minutes. Do you want to interrupt this call?” The calling party would then say either “yes” or “no,” with the IVR system identifying the spoken response.

Since certain changes may be made in the above-described call priority management system for a communication network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for communicating with at least one terminal over a network, said method comprising the steps of:
determining if a communication initiated from a first terminal to a second terminal is a priority communication, said second terminal being in communication with a third terminal; and, if so,
establishing a communication channel between the first and second terminals, wherein the communication between the second and third terminals is at least temporarily interrupted.

2. The method of claim 1 wherein said determination is based at least in part on information relating to at least one of a user of the first terminal and the communication initiated from the first terminal.

3. The method of claim 2 wherein:
the information comprises at least one of a communication identifier of the first terminal and an identifier associated with the user of the first terminal; and
the determination of whether the initiated communication is a priority communication is based at least in part on whether said at least one of the first terminal communication identifier and the identifier associated with the user of the first terminal is listed as having priority status in a record associated with at least one of the second terminal and a user of the second terminal.

4. The method of claim 2 wherein:
the information comprises a code originating from the first terminal; and
the determination of whether the initiated communication is a priority communication is based at least in part on whether the code matches a priority code in a record associated with at least one of the second terminal and a user of the second terminal.

5. The method of claim 2 wherein:
the information comprises a communication identifier of the second terminal; and
the determination of whether the initiated communication is a priority communication is based at least in part on whether the communication identifier is a priority communication identifier of the second terminal, said second terminal having a primary communication identifier and the priority communication identifier assigned thereto.

6. The method of claim 1 further comprising:
providing information to the first terminal relating to the communication between the second and third terminals.

7. The method of claim 6 wherein the determination of whether the initiated communication is a priority communication is based at least in part on command data received from the first terminal, said command data indicating whether a user of the first terminal desires to have the communication between the second and third terminals interrupted.

8. The method of claim 7 further comprising:
transmitting, to the first terminal, at least one identifier associated with at least one of the third terminal and a user of the third terminal, whereby said at least one identifier may be conveyed to the user of the first terminal for use by the user of the first terminal in deciding whether to interrupt the communication between the second and third terminals.

9. A method for communicating with at least one terminal over a network, said method comprising the steps of:
at least temporarily interrupting an active communication between a first terminal and a second terminal, without intervention of a user of the first terminal, for establishment of a communication link between the first terminal and a third terminal that initiated communication with the first terminal.

10. The method of claim 9 further comprising:
comparing information associated with the initiated communication to a record associated with at least one of the first terminal and the user of the first terminal; and
determining whether to interrupt the active communication between the first and second terminals based at least in part on said comparison.

11. The method of claim 10 further comprising:
providing information to the third terminal relating to the communication between the first and second terminals.

12. The method of claim 11 wherein the determination of whether to at least temporarily interrupt the communication between the first and second terminals is further based on command data received from the third terminal, said command data indicating whether a user of the third terminal desires to have the communication between the first and second terminals interrupted.

13. The method of claim 12 further comprising:
transmitting, to the third terminal, at least one identifier associated with at least one of the second terminal and a user of the second terminal, whereby said at least one identifier may be conveyed to the user of the third terminal for use by the user of the third terminal in deciding whether to interrupt the communication between the first and second terminals.

14. The method of claim 10 wherein:
the record includes at least one priority identifier;
the information comprises, at least in part, an identifier associated with one of the third terminal and a user of the third terminal; and
the determination of whether to at least temporarily interrupt the communication between the first and second terminals is based at least in part on whether the identifier associated with one of the third terminal and the user of the third terminal is listed in the record as one of said at least one priority identifier.

15. The method of claim 10 wherein:
the record includes at least one priority code;
the information comprises a code originating from the third terminal; and
the determination of whether to at least temporarily interrupt the communication between the first and second terminals is based at least in part on whether the code originating from the third terminal matches one of said at least one priority code in the record.

16. The method of claim 10 wherein:
the information comprises a communication identifier of the first terminal; and
the determination of whether to at least temporarily interrupt the communication between the first and second terminals is based at least in part on whether the communication identifier is designated as a priority communication identifier of the first terminal in the record.

17. The method of claim 16 wherein:
the first terminal includes a primary communication identifier and the priority communication identifier; and
the communication between the first and second terminals is not interrupted if said information comprises the primary communication identifier.

18. The method of claim 9 further comprising:
determining whether to interrupt the communication between the first and second terminals based at least in part on: (i) an identifier associated with one of the third terminal and a user of the third terminal, said identifier being compared to a record associated with one of the first terminal and a user of the first terminal for a determination of whether said one of the third terminal and the user of the third terminal is authorized to interrupt communications of the first terminal; and (ii) information received from the third terminal relating to whether the user of the third terminals desires to interrupt the communication between the first and second terminals.

19. A method for communicating with at least one terminal over a network, said method comprising the steps of:
executing information on a first terminal relating to an active communication between a second terminal and a third terminal, upon initiation of a communication from the first terminal to the second terminal; and
transmitting information relating to whether a user of the first terminal desires to at least temporarily interrupt said active communication.

20. The method of claim 19 wherein the executed information comprises at least one displayed identifier of at least one of the third terminal and a user of the third terminal.
